(19) United States
(12) Patent Application Publication
(10) Pub. No.: US 2026/0023977 A1
(43) Pub. Date: Jan. 22, 2026

(54) ARTIFICIAL INTELLIGENCE DEVICE FOR FEEDBACK-AWARE FINE-TUNING AND METHOD THEREOF

(71) Applicant: LG ELECTRONICS INC., Seoul (KR)

(72) Inventors: Yanan CHEN, Toronto (CA); Ali PESARANGHADER, Toronto (CA)

(73) Assignee: LG ELECTRONICS INC., Seoul (KR)

(21) Appl. No.: 19/272,864

(22) Filed: Jul. 17, 2025

Related U.S. Application Data
(60) Provisional application No. 63/672,692, filed on Jul. 17, 2024.

(51) Int. Cl. G06N 3/09

(52) U.S. Cl. CPC G06N 3/09

(57) ABSTRACT

A method for controlling an artificial intelligence (AI) device can include generating a plurality of training data instances based on providing a plurality of queries to a language model to generate a plurality of initial outputs, and analyzing the plurality of initial outputs to generate plurality of feedback signals, each of the plurality of feedback signals including a natural language evaluation. Also, the method can further include creating a structured training dataset by arranging the plurality of training data instances into a data structure including the plurality of queries, the plurality of initial outputs, and the plurality of feedback signals, fine-tuning a target language model based on the structured training dataset to generate a fine-tuned target model, and outputting the fine-tuned target model.

### CROSS-REFERENCE TO RELATED APPLICATIONS

This non-provisional application claims priority under 35 U.S.C. § 119 (e) to U.S. Provisional Application No. 63/672,692, filed on Jul. 17, 2024, the entirety of which is hereby expressly incorporated by reference into the present application.

### BACKGROUND

### Field

The present disclosure relates to a method and device for feedback aware fine-tuning (FAFT) of artificial intelligence (AI) models to improve performance on complex generative tasks. Particularly, the method can implement a feedback-aware framework that leverages descriptive feedback during supervised fine-tuning to systematically improve a model's ability to adhere to complex constraints and quality standards, thereby increasing reliability and utility.

### Discussion of the Related Art

Artificial intelligence (AI) continues to transform various aspects of society and help users by powering advancements in various fields, particularly with regards to interactive applications, such as large language models (LLMs), virtual assistants, chat-bots, and knowledge base question answering (KBQA) systems.

As AI models, such as LLMs, become integrated into more complex applications, such as automated planners, code generators and sophisticated interactive agents, there is an increasing need to fine-tune their behavior to ensure that the outputs are accurate and aligned with specific and complex user requirements.

Prior approaches to fine-tuning often depend entirely on the quality and comprehensiveness of a training dataset that consists of curated input-output pairs representing ideal examples. However, creating a large-scale dataset of high-quality examples is a significant bottleneck. This process is often prohibitively expensive and time-consuming, and the resulting dataset may still fail to cover the vast array of scenarios the model will encounter, thus limiting the model's ability to generalize.

Further, by training only on correct examples, the model learns to associate a given input with a single correct output, but it may not learn why that output is correct or why other potential outputs are incorrect. For example, prior approaches often fail to teach the model how to reason about constraints and evaluate its own outputs, thereby limiting its robustness when faced with novel or complex instructions that require multi-step reasoning.

Other approaches introduce significant complexity and instability into the training process, such as training a separate reward model to score outputs, followed by complex and often unstable reinforcement learning algorithms to update the language model. This type of multi-stage process can be computationally expensive and difficult to implement and tune correctly.

In addition, some methods offer a self-refinement approach that relies on a complex refiner model that increases computational overhead and system complexity, which often depends on the advanced reasoning capabilities found only in the largest, most sophisticated and often proprietary cloud-based LLMs, making them less accessible and less practical for a wide range of smaller, open-source models.

Thus, a need exists for a more stable and efficient fine-tuning method that can directly teach an AI model how to incorporate feedback and reason about correctness.

Further, a need exists for a fine-tuning framework that moves beyond using only simple input-output pairs to directly teach a language model how to reason about the quality of its generated outputs.

Also, a need exists for a fine-tuning method that is both efficient and broadly accessible, which can reduce dependency on having to use only the largest and most advanced proprietary models. Such a method is needed to enable a wide range of language models to be effectively aligned with user intent.

### SUMMARY OF THE DISCLOSURE

The present disclosure has been made in view of the above problems and it is an object of the present disclosure to provide a device and method that can provide improved fine-tuning of large language models (LLMs) to enhance their performance on complex, instruction-driven tasks, in the field of artificial intelligence (AI). Further, the method can provide for improved model alignment and reliability by implementing a feedback-aware fine-tuning (FAFT) framework in which a model is directly trained to generate outputs conditioned on descriptive natural language feedback, which can improve stability and reduce complexity.

An object of the present disclosure is to provide an artificial intelligence (AI) device and method for fine-tuning large language models (LLMs) to improve their reliability and ability to follow complex instructions. The method can utilize a two-phase framework including a data generation phase and a fine-tuning phase to teach a model how to incorporate corrective feedback. For example, during the data generation phase, a language model can produce an initial output for a given query, and a feedback generator, which can be another model or a set of heuristic rules or modules, can analyze the initial output to produce a descriptive feedback signal evaluating its quality. A structured training dataset can then be created in which each data instance can include the query, the corresponding feedback signal and the initial output, arranged to condition a target LLM during a supervised fine-tuning process. Then, the target LLM can be fine-tuned on this dataset to learn to generate outputs that are responsive to both a query and its associated feedback, and during a later inference stage, the fine-tuned model can be prompted with a new query and a predetermined feedback signal corresponding to successful output to guide the model in producing a high-quality final output. This can produce a more robust and reliable language model without the need for expensive manually annotated datasets or the instability and complexity of other reinforcement learning techniques, thereby improving the performance and safety of LLMs in a wide range of applications.

Another object of the present disclosure is to provide a method for controlling an artificial intelligence (AI) device that can include generating a plurality of training data instances based on providing a plurality of queries to a language model to generate a plurality of initial outputs, and analyzing the plurality of initial outputs to generate plurality of feedback signals, each of the plurality of feedback signals including a natural language evaluation, creating a structured training dataset by arranging the plurality of training data instances into a data structure including the plurality of queries, the plurality of initial outputs, and the plurality of feedback signals, fine-tuning a target language model based on the structured training dataset to generate a fine-tuned target model, and outputting the fine-tuned target model.

It is another object of the present disclosure to provide a method that further include performing, by the fine-tuned target model, an inference task based on an input prompt including a new query and a predetermined feedback signal indicating a successful outcome, to generate a final output responsive to the new query.

Yet another object of the present disclosure is to provide a method, in which the predetermined feedback signal indicating a successful outcome includes a plurality of feedback fields, and each of the plurality of feedback fields is set to a value representing success.

An object of the present disclosure is to provide a method, in which the analyzing the plurality of initial outputs is performed by a feedback generator based on a set of predefined heuristic rules.

Another object of the present disclosure is to provide a method, in which the set of predefined heuristic rules includes at least one of a commonsense constraint for checking logical consistency within a corresponding initial output or a hard constraint for verifying adherence to a requirement specified in a corresponding query.

An object of the present disclosure is to provide a method the further includes arranging each of the plurality of training data instances in an order that includes a corresponding query and a corresponding feedback signal preceding a corresponding initial output to condition the target language model during the fine-tuning.

Yet another object of the present disclosure is to provide a method, in which the fine-tuning is supervised fine-tuning performed in an auto-regressive manner.

An object of the present disclosure is to provide a method, in which the creating the structured training dataset further includes combining the plurality of training data instances with a plurality of ground truth data instances to create an augmented training dataset, and each of the plurality of ground truth data instances includes a ground truth output and a corresponding ground truth feedback signal.

Another object of the present disclosure is to provide a method, in which the generating the plurality of training data instances includes setting a temperature hyper-parameter of the language model to a value greater than zero.

An object of the present disclosure is to provide a method, in which the plurality of queries are based on a task selected from a group including one or more of travel planning, code generation, creative writing, legal document drafting, and customer service response generation.

Another object of the present disclosure is to provide an artificial intelligence (AI) device including a memory configured to store information for a language model, and a controller configured to generate, via a processor in the AI device, a plurality of training data instances based on providing a plurality of queries to a language model to generate a plurality of initial outputs, and analyzing the plurality of initial outputs to generate plurality of feedback signals, each of the plurality of feedback signals including a natural language evaluation, create a structured training dataset by arranging the plurality of training data instances into a data structure including the plurality of queries, the plurality of initial outputs, and the plurality of feedback signals, fine-tune a target language model based on the structured training dataset to generate a fine-tuned target model, and output the fine-tuned target model.

An object of the present disclosure is to provide a non-transitory computer readable medium storing computer-executable instructions that when executed by a processor, cause the processor to perform the operations of generating a plurality of training data instances based on providing a plurality of queries to a language model to generate a plurality of initial outputs, and analyzing the plurality of initial outputs to generate plurality of feedback signals, each of the plurality of feedback signals including a natural language evaluation, creating a structured training dataset by arranging the plurality of training data instances into a data structure including the plurality of queries, the plurality of initial outputs, and the plurality of feedback signals, fine-tuning a target language model based on the structured training dataset to generate a fine-tuned target model, and outputting the fine-tuned target model.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example encoder-decoder based transformer architecture for a large language model according to an embodiment of the present disclosure.

FIG. 5 illustrates an example flow chart for a method of controlling an AI device according to an embodiment of the present disclosure.

FIG. 6 illustrates an overview of the architecture and process flow of a feedback-aware fine-tuning (FAFT) framework, according to an embodiment of the present disclosure.

FIG. 7 illustrates an overview of a process flow of the feedback-aware fine-tuning (FAFT) framework, according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user. For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

Also, the self-driving vehicle can be regarded as a robot having a self-driving function.

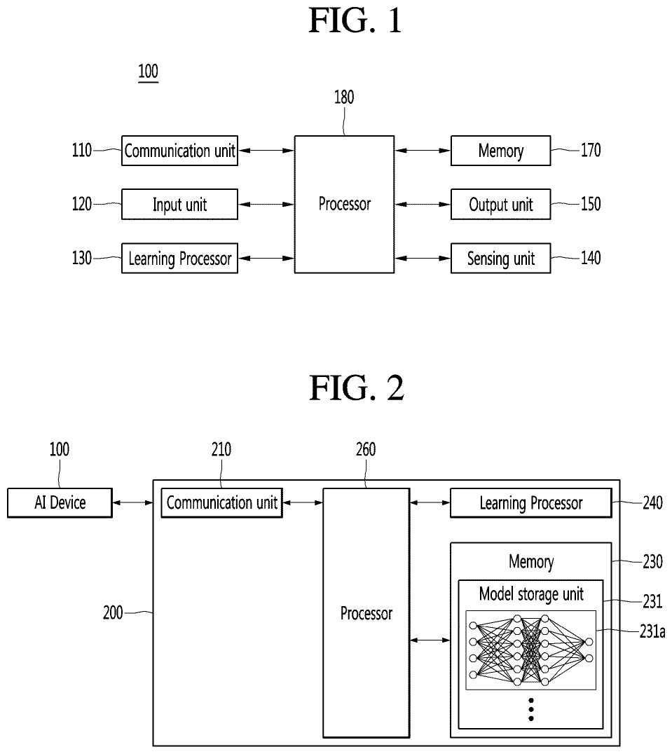

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

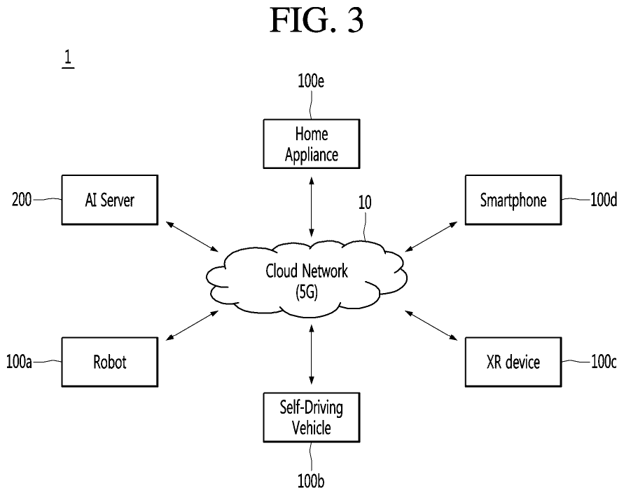

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

For example, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement an AI model to generate output based on a plurality of modalities. Also, the generated output can be used by AI systems in various downstream related tasks other than text generate (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and produce an answer to a query, carry out an action or movement, animate a displayed avatar or a recommend an item or action.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100c and 200 can communicate with each other through a base station, but can directly communicate with each other without using a base station.

The AI server 200 can include a server that performs AI processing and a server that performs operations on big data. According to embodiments, the AI model can be fully implemented on an edge device (e.g., locally on devices 100a to 100c) or fully implemented AI server 200 in which an edge device collected the raw audio and video signals to provide to the AI server 200. According to another embodiment, parts of the AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100c.

In addition, the AI server 200 can learn the artificial neural network according to the machine learning algorithm instead of the AI devices 100a to 100c, and can directly store the learning model or transmit the AI model to the AI devices 100a to 100c.

Further, the AI server 200 can receive input data from the AI devices 100a to 100c, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart washing machine or dryer, smart refrigerator or other display device, which can implement one or more of a large language model (LLM), a generative AI model, a chat-bot, a digital avatar assistant, an online shopping assistant or concierge, a question and answering system or a recommendation system, etc. The method can be in the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

In addition, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, generate an output or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Also, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's emotional state and personal preferences.

According to an embodiment, the AI device 100 can provide a method for feedback aware fine-tuning (FAFT) a generative AI model by training on a dataset including queries, initial outputs, and corresponding natural language feedback signals, thereby conditioning the model to generate a final output responsive to both a query and a feedback signal to improve its alignment with complex instructions.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, embodiments of the present disclosure relate to the field of artificial intelligence (AI) and machine learning, and more particularly, to methods and systems for fine-tuning of large language models to improve their reliability and alignment with complex instructions.

For example, embodiments of the present disclosure can provide for the improved fine-tuning of large language models by training a model to generate outputs conditioned on natural language feedback, which can enhance model reliability and instruction following capabilities for complex applications such as automated planning, content creation, and interactive agents.

As discussed above, efforts for adapting and improving AI models for complex tasks faces several fundamental challenges. For example, the performance of advanced artificial intelligence systems, such as large language models (LLMs) tasked with generating structured outputs like travel itineraries, software code, or detailed reports, is often dependent on the method used to fine-tune their behavior.

For example, for an LLM to accurately generate content that adheres to a complex set of user-defined constraints and quality standards, the model should be developed using a process that teaches it to reason about the requirements of a given task. The existing methods for achieving this present significant challenges.

For example, Supervised Fine-Tuning (SFT) can involve training a model on a dataset of curated input-output pairs, which can limit its ability to teach complex reasoning. For example, a mode trained with SFT to generate travel plans might learn to produce a valid plan for a specific city from its training examples. If a new query asks for a plan in a different city but with a strict budgetary constraint of $2,000, the model might fail to adhere to the budget because it has only learned to mimic the structure of previously seen plans, not the underlying concept of satisfying a budget constraint. The model may learn what a correct output looks like but not why it is correct, thus limiting its ability to generalize to new and varied constraints.

Other approaches, such as Reinforcement Learning from Human Feedback (RLHF), attempt to overcome some limitations of SFT by using a reward model to guide the training process. However, this introduces significant complexity and computational expense, and even instability.

For instance, to align a chatbot using RLHF, it may first collect a large dataset of human preference judgments (e.g., rating which of two responses is better), then train a separate reward model on this data, and finally use a complex reinforcement learning algorithm like Proximal Policy Optimization (PPO) to fine-tune the chatbot. This can be difficult to stabilize, e.g., the language model may learn to exploit the reward model to achieve a high score with outputs that are nonsensical or misaligned with the true user intent (e.g., such as reward hacking).

Another technique can involve a self-refinement process, where a model generates an output and then critiques its own work and attempts to improve it. A significant drawback of this approach is its reliance on the advanced capabilities of only the largest and most powerful proprietary models. Also, this complicated process can be inefficient and increases latency and computational costs during inference. For example, using such a method to generate code could require the model to first write the code, then analyze it for errors or inefficiencies, and then rewrite the code, making the process slow and resource-intensive.

Accordingly, a need exists for an improved fine-tuning system and method that can efficiently teach a model to incorporate feedback and reason about correctness within a stable training process.

According to an embodiment, a system can implement a feedback-aware fine-tuning (FAFT) framework that overcomes the limitations of prior approaches. For example, the framework can be employed in a two-phase process that integrates feedback generation directly into the data preparation stage for supervised learning.

In a first phase, a language model can be used to generate an initial output for a given query, and a feedback generator (e.g., a module including a set of programmatic heuristic rules or another specialized LLM model or agent), can then analyze this output to produce a descriptive, natural language feedback signal. This process can create a structured training dataset of triplets including a query, the corresponding feedback signal, and the initial output.

In a second phase, a target language model can be fine-tuned on this dataset, thereby directly teaching the model to generate outputs that are conditioned on both a query and an associated critique.

The FAFT framework can be applied to a generative LLM based model as an example embodiment. For example, the FAFT framework can also be applied to other types of generative AI models, such as text-to-image models for creating visual media, text-to-code models for generating software programs, and models that generate structured data outputs such as JSON or XML.

However, LLM based models provide various advantages such as their ability to process and generate responses based on natural language feedback, which can align with the FAFT framework's use of descriptive critiques, and their advanced reasoning capabilities across a wide array of text-based generative tasks make them a useful platform for implementing the feedback-aware fine-tuning methodology.

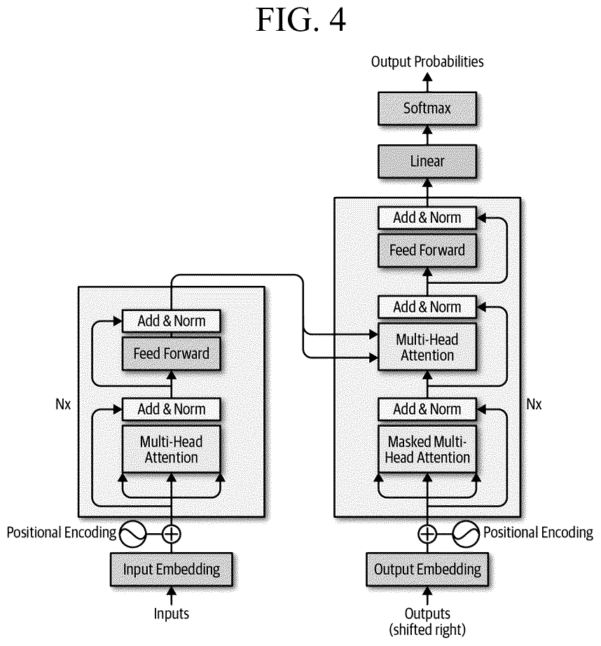

FIG. 4 illustrates an example encoder-decoder based transformer architecture for a large language model according to an embodiment of the present disclosure. For example, the method can leverage one or more large language models (LLMs). According to an embodiment, the LLM can be based on an encoder-decoder architecture, which employs self-attention mechanisms.

Further, these attention mechanisms can allow the model to weigh the importance of different parts of an input sequence (e.g., words in a sentence or sentences in a document) when processing information to allow the model to capture long-range dependencies and contextual relationships effectively, which is particularly relevant for understanding complex user queries or detailed product descriptions.

According to an embodiment, the LLM can undergo its own pre-training phase, in which the LLM is trained on a massive and diverse amount of text and code. During this unsupervised or self-supervised learning stage, the model can learn fundamental language patterns, grammatical structures, factual knowledge, and even reasoning capabilities (e.g., predicting masked words or the next sequence of text).

According to an embodiment, the LLM portion can be subject to a fine-tuning phase. Fine-tuning can involve further training the pre-trained model on smaller, more specialized datasets tailored to specific tasks (e.g., question answering, summarization, specific domain knowledge) or to align the model's behavior with desired characteristics, such as improved instruction following or safety protocols. According to embodiments, the AI model can advantageously utilize pre-trained LLMs, potentially without requiring extensive task-specific fine-tuning for its core agent functionalities. For example, according to an embodiment, the AI model can be LLM agnostic, but embodiments are not limited thereto.

For example, the LLM portion can operate by processing textual inputs (e.g., prompts) which can include questions, instructions, or other text intended to elicit a specific response. The LLM can leverage its learned knowledge to generate a corresponding textual output, such as an answer, a summary, or other contextually relevant content. Also, according to an embodiment, the LLM portion can be multi-modal to accept and operate on other types of input, such as images, video, etc.

In some embodiments, one or more components of the FAFT framework can be implemented as an autonomous or semi-autonomous AI agent. An AI agent, in this context, can be understood as a computational system (e.g., powered by an LLM) that is designed to obtain inputs, reason about those inputs, and take actions to achieve a predefined goal.

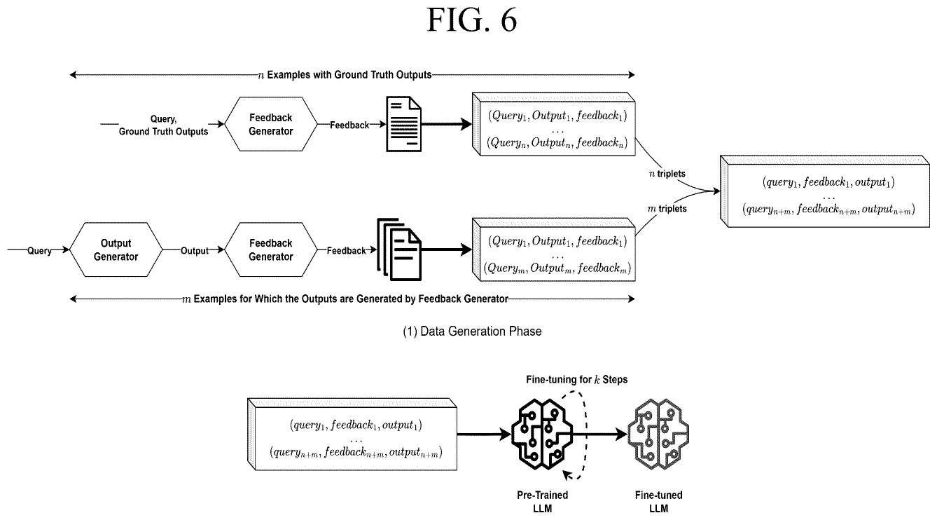

For example, with brief reference to FIG. 6, according to an embodiment and discussed in more detail below, a feedback signal generator (606) can be configured as a specialized AI agent or evaluator agent, tasked with the goal of ensuring output quality. In such a configuration, the evaluator agent can receive the initial output (604), analyze it, and then generate a corresponding feedback signal (608).

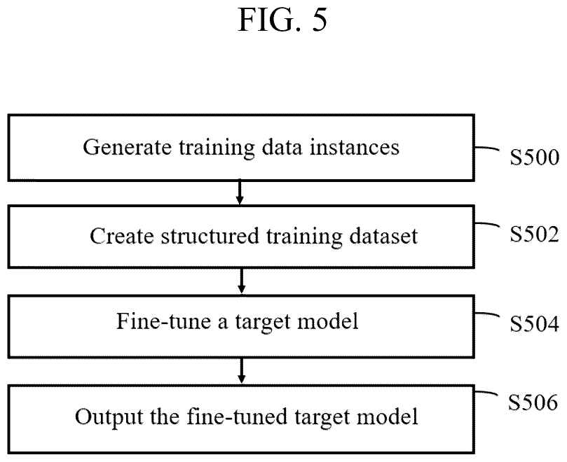

FIG. 5 shows an example flow chart of a method according to an embodiment of the present disclosure. For example, according to an embodiment, a method for controlling an AI device can include generating, by a processor in the AI device 100, a plurality of training data instances based on providing a plurality of queries to a language model to generate a plurality of initial outputs, and analyzing the plurality of initial outputs to generate plurality of feedback signals, each of the plurality of feedback signals including a natural language evaluation (e.g., S500), creating a structured training dataset by arranging the plurality of training data instances into a data structure including the plurality of queries, the plurality of initial outputs, and the plurality of feedback signals (e.g., S502), fine-tuning a target language model based on the structured training dataset to generate a fine-tuned target model (e.g., S504), and outputting the fine-tuned target model (e.g., S506).

FIG. 6 illustrates an overview of the architecture and process flow of a feedback-aware fine-tuning (FAFT) framework, according to an embodiment of the present disclosure. For example, according to an embodiment, the FAFT framework can be implemented as a cohesive architecture of interconnected modules designed to implement a two-phase workflow. The framework can include a training/fine-tuning phase for training an AI model based on feedback, and an inference phase in which the trained model is utilized to generate high-quality outputs. Also, as shown in FIG. 6, the training/fine-tuning phase can include two parts, such as a data generation phase for generating training samples, and a fine-tuning phase for fine tuning an AI model based on the generated training samples.

For example, the training/fine-tuning phase can create a training dataset that explicitly encodes the relationship between a task, an attempted output, and a feedback. The feedback can include a critique of that output, and then this training dataset can be used to train an AI mode, such as a large language model.

According to an embodiment, the process can include the generation of individual training instances. Queries can be provided as an input to human annotators or an initial large language model (LLM) to generate some ground truth outputs, depending on embodiments. The query can be a task description, a question, or any form of instruction.

Further in this example, the LLM can be a pre-trained, general-purpose generative model configured to produce a text-based response. In response to the query, the LLM can generate an initial output that corresponds to a preliminary attempt to satisfy the request in the query.

Further, this initial output can be subjected to an evaluation process executed by a feedback generator. The feedback generator can be a module configured to analyze the initial output and determine its quality with respect to one or more predefined criteria. These criteria can include, for example, adherence to constraints specified in the query, logical consistency, or factual correctness against a reference data source (e.g., programming logic, such as if/then statements, etc.). Also, for generating ground truth feedback (e.g., upper path), a separate feedback generator can be used, which can be a very accurate feedback generator or a group of human annotators.

In more detail, as shown in FIG. 6, according to an embodiment, the training/fine-tuning phase can be implemented using one or more distinct paths to create a robust and comprehensive dataset or an augmented training dataset. For example, an upper path in the workflow can be configured for generating ground truth feedback, which can serve as a small, high-quality training set that has been specifically curated to be especially accurate, e.g., by human annotators or a specifically designed program, according to embodiments. In this path, the system can start with query, ground truth output pairs, and the feedback generator can produce a corresponding feedback that is known to be correct (e.g., produced by human annotators), or at least very accurate or 100% accurate (e.g., produced by highly sophisticated programming logic or validated LLM).

Also, according to embodiments, the output received in the upper path can be a ground truth output that was also made by human annotators based on the corresponding query for improved accuracy, or can be an output generated by a highly sophisticated AI agent or LLM model, or programming logic.

Further in this example, the lower path in FIG. 6 can be configured to automatically generate a larger volume of synthetic training data samples. In this lower path, the system can start with a query, use a language model to generate an initial output, and then use the feedback generator, e.g., via programming logic or a separate LLM, to create the corresponding feedback.

Then, the final structured training dataset can be created as a combined augmented training data set, which can include a random mix of the ground truth samples from the upper path and the synthetic samples from the lower path to provide the model with high-quality examples and a diverse, wide variety of generated scenarios.

For example, according to an embodiment, to increase the diversity of the generated training samples, the temperature hyper-parameter for the language model generating the initial outputs and/or for an LLM-based feedback generator can be set to a value greater than zero (e.g., >0.0), thereby introducing randomness into their respective output to create more diverse samples.

In more detail, according to embodiments, the feedback generator can be implemented using various methods, such as a set of programmatic heuristic rules, a separate AI model, such as a distinct instance of a large language model.

Further in this example, the feedback generator can produce a feedback. According to an embodiment, the feedback can be more than a mere numerical score, it can be a descriptive, natural language critique or evaluation. For example, the feedback can include one or more statements that identify specific flaws or confirm the correctness of aspects of the initial output. This use of natural language feedback can provide a rich and highly informative training signal for the subsequent fine-tuning process that can improve interpretability of the model.

According to an embodiment, the query, the initial output, and the feedback can be assembled into a structured data triplet. These triplets can be collected to form a structured training dataset. The specific arrangement of data within each triplet can be configured to teach the model to view the output as a consequence of both the query and the feedback. For example, the data can be ordered as (query, feedback, output) to prepare the model for a conditional generation task.

As discussed above, this structured training dataset can be an augmented training dataset that mix of the ground truth samples from the upper path and the synthetic samples from the lower path, embodiments are not limited thereto.

Further in this example, as shown in the bottom of FIG. 6, the augmented training dataset can be used to fine-tune a pre-trained LLM to generate a fine-tuned target model (e.g., a fine-tuned LLM.

Then, in a second phase (e.g., the inference phase), the resulting fine-tuned target model can be utilized to perform new tasks. The process can include a user or another system providing a new query.

According to an embodiment, in addition to the new query, a predetermined “success” feedback can be provided to the model (e.g., via a predetermined internal prompting mechanism). This can be a specially constructed feedback signal that indicates to the model that the desired outcome is a successful one, effectively instructing the model to generate an output that would not trigger any of the negative feedback it learned about during training.

In addition, new query and the predetermined “success” feedback can be combined into a single prompt and provided to the fine-tuned target model. Having been trained to generate outputs that satisfy the conditions of a given feedback signal, the model can interpret the “success” signal as a command to generate a high-quality response that adheres to all implicit and explicit constraints of the new query. The model can then produce a final output that is more reliable, accurate and aligned with user intent.

According to an embodiment, the various language model components do not need to be physically distinct models. For example, the initial language model used for generating the initial output and the fine-tuned target model can be the same underlying model, which is iteratively improved through the FAFT process. Similarly, the feedback generator, if implemented with a language model, can be a distinct functional role assumed by a single large language model that is provided with a different set of operational instructions for the evaluation task (e.g., via prompt engineering).

In other words, according to an embodiment, the training/fine-tuning phase can be implemented as a multi-stage process. In a first stage, which can be referred to as an output generation stage, a language model can be provided with an input including a query and, optionally, associated reference information.

For example, the reference information can act as a knowledge base, containing necessary details, such as entities and their attributes, e.g., in a structured or tabular format, that the model can utilize to perform the task. The output of this stage can be a generated output or plan that satisfies at least some of the constraints defined in the input query.

In a second stage, a feedback collection process can be performed for each generated output. The input for this stage can be the query and its corresponding generated output from the previous stage. A feedback generator module can analyze these inputs and produce a corresponding feedback signal as its output. This feedback can be based on a set of human-designed heuristic rules designed to evaluate the generated output against various quality criteria.

For example, these heuristic rules can be divided into commonsense constraints and hard constraints.

Commonsense constraints can enforce logical consistency within the output, such as ensuring a process starts and ends in a required state, that entities mentioned in the output are valid according to the reference information, or that entities are not repeated where repetition is disallowed.

Hard constraints can involve verifying that the output adheres to specific requirements explicitly stated in the query, such as satisfying a budget limit, a style preference, or a specific attribute requirement (e.g., that a selected component must be “pet-friendly”).

Also, the feedback signal itself can be structured, e.g., as a series of key-value pairs where each key represents an evaluation criterion and the value indicates a success or failure state, often accompanied by a natural language reason for the failure.

In a third stage, a data preparation process can be executed. Having generated a feedback signal for each query and output pair, the system can create a data sample instance in a (query, output, feedback) format. According to an embodiment, the system can create a combined, augmented training dataset by merging these synthetically generated samples with a curated set of original or ground-truth samples that are designated with a “success” feedback signal.

Then, to prepare the data for training, the order of the columns in each data sample can be changed to a (query, feedback, output) format (e.g., the locations of output and feedback can be switched). This specific ordering can help for the subsequent fine-tuning step to properly condition the model.

In a fourth stage, a supervised fine-tuning process can be performed. For example, a target language model can be directly fine-tuned on the prepared training dataset from the previous stage, which can be in the (query, feedback, output) format. This fine-tuning can be conducted in a supervised, auto-regressive manner. This process can ensure that the resulting fine-tuned model is conditioned to generate an output that reflects the input query and the provided feedback signal within the prompt.

Further still in this example, during the subsequent inference phase, the format of the input prompt can be kept consistent with the training format to ensure reliable performance. The input prompt for inference can include the reference information, the new query, and the feedback signal.

However, according to an embodiment, a difference in the inference process can come from the deliberate setting of the feedback signal. For inference, the feedback signal, including all of its constituent fields or slots, can be deliberately set to a “success” value. The goal of this configuration is to instruct the model to generate a correct and appropriate output from the outset. By providing an all “success” feedback signal, the model can be guided to produce a final plan or output that embodies the characteristics of a successful generation.

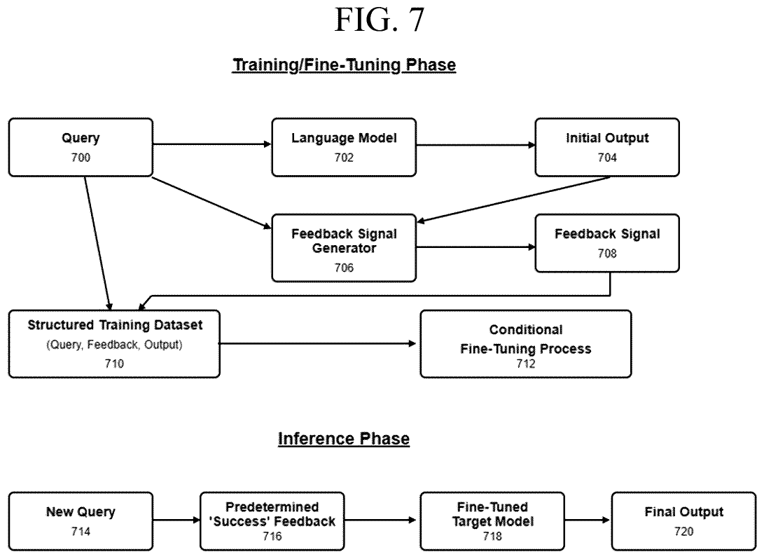

FIG. 7 illustrates a detailed overview of the process flow of the feedback-aware fine-tuning (FAFT) framework, according to an embodiment of the present disclosure. The framework can be conceptually divided into a training/fine-Tuning Phase where a model is prepared, and an Inference phase where the prepared model is used for generating new content. The following paragraphs detail example inputs and outputs at each stage of this process flow, according to an embodiment.

The process can include a training/fine-tuning phase. The initial input to the AI device 100 can be a query (700), which can be a textual instruction, a question, or any other form of prompt that defines a task to be performed. The query (700) can be provided as an input to a language model (702), such as an LLM. The output of the language model (702) at this stage is an initial output (704), which is a generative response to the query (700). Alternatively, for generating ground truth samples as discussed above, a ground truth output can be manually produced by a human annotator, but embodiments are not limited thereto.

Following the generation of the initial output (704), a feedback generation can be initiated. The initial output (704) can serve as a primary input to the feedback signal generator (706). In some embodiments, the language model (702) itself can also provide input or context to the feedback signal generator (706). The feedback signal generator (706) can process its inputs and produce a feedback signal (708) as its output. This feedback signal (708) can be a structured or natural language critique that evaluates the quality and correctness of the initial output (704).

Further in this example, the next stage can involve the creation of a training corpus. The structured training dataset (710) can be created by taking the query (700), the initial output (704), and the feedback signal (708) as its inputs. The output of this stage is the structured training dataset (710) itself, which can include a plurality of data instances, in which each instance can be formatted as a triplet containing the query, its corresponding initial output, and the associated feedback signal.

Also, the structured training dataset (710) can then serve as the primary input to the conditional fine-tuning process (712). The conditional fine-tuning process (712) can take the structured training dataset (710) and use it to train or fine-tune a language model. The final output of the training/fine-tuning phase is the fine-tuned target model (718), e.g., a model that has been specifically trained to generate outputs that are conditioned on both a query and a feedback signal.

Further still in this example, the second phase of the framework is the inference phase, which utilizes the fine-tuned model created in the previous phase. The process can include two distinct inputs, such as a new query (714), which can be a novel task instruction provided by a user or another system, and a predetermined “success” feedback (716). This “success” feedback can be a specially crafted input that signals to the model that a high-quality, correct output is desired.

For example, the predetermined “success” feedback (716) can help guide the model to generate a final output (720) that avoids the common failure modes it may have been trained on, effectively instructing the model to produce a response that satisfies all known constraints and quality standards from the outset.

Then, the new query (714) and the predetermined “success” feedback (716) can be provided to the fine-tuned target model (718). The fine-tuned target model (718) can process this combined input and, based on the knowledge acquired during the conditional fine-tuning process (712), can generate a final output (720). This final output (720) is the result of the inference process and corresponds to a high-quality, refined response to the new query (714), guided by the instruction to achieve a successful outcome.

According to an embodiment, the following section of the description provides a non-limiting example of the feedback-aware fine-tuning (FAFT) framework as applied to a travel planner application. However, as discussed above, the FAFT method can be applied to other types of use case scenarios. In this embodiment, the system can be configured to generate a multi-day travel itinerary based on a user's request, adhering to various constraints such as budget, destination, accommodation preferences, and transportation methods.

The process can include an output generation stage. The input at this stage is a query from a user, which can include various details for the desired trip. For example, a query input can be: “Can you create a travel plan for a group of 4 departing from Seattle and heading to San Francisco for 3 days, from Mar. 6 to Mar. 8, 2022? Our budget is $2,900. We are bringing pets, so accommodations need to be pet-friendly. We would also prefer to avoid flying for transportation.” This query, along with associated reference information (e.g., tables of available hotels, restaurants, and transportation options), can be provided to a language model. The output of this stage can be an initial generated travel plan or itinerary. For example, this initial plan is a first attempt and may contain errors or fail to meet all constraints.

Table I below shows an example of a prompting mechanism input to the model for a query.

TABLE I

QUERY:
Can you create a travel plan for a group of 4 departing
from Seattle 2 and heading to San Francisco for 3 days,
from March 6 th to March 8th, 2022? Our budget is $2,900. We
are bringing pets, so accommodations need to be pet-
friendly. We are interested in trying Mexican, French,
American, and Mediterranean cuisines during our visit. We
would also prefer to avoid flying for transportation.
TRAVEL PLAN:
Day 1:
Current City: from Seattle to San Francisco
Transportation: Self-Driving from Seattle to San Francisco,
Duration: 12 hours 28 mins, Cost: $65
Breakfast: -
Attraction: -
Lunch: -
Dinner: Anupan Eating Point, San Francisco
Accommodation: [symbol] in Down town Brooklyn Parkslop, San
Francisco
Day 2:
Current City: San Francisco
Transportation: -
Breakfast: Coffee & Chai Co., San Francisco
Attraction: Golden Gate Bridge, San Francisco: Golden Gate
Park, San Francisco
Lunch: Bonne Bouche, San Francisco
Dinner: Express, San Francisco
Accommodation: [symbol] in Down town Brooklyn Parkslop, San
Francisco
Day 3:
Current City: from San Francisco to Seattle
Transportation: Self-Driving from San Francisco to Seattle,
Duration: 12 hours 25 mins, Cost: $65
Breakfast: Gupta's [symbol] , San Francisco
Attraction: PIER [symbol] , San Francsico
Lunch: Shammi Bhai Lassi Wala, San Francisco
Dinner: -
Accommodation: - [symbol]
indicates data missing or illegible when filed

Next, in a feedback collection stage, the initial travel plan can be evaluated. The input to this stage is the original query and the generated itinerary. A feedback generator module, which can be configured with a set of heuristic rules specific to travel planning, analyzes the itinerary.

For example, a commonsense rule can be to check if the trip is a closed circle (e.g., returns to the origin city), while a hard constraint rule can be to verify that the selected accommodation is pet-friendly as specified in the query. Other rules can validate that restaurants or attractions exist in the reference information, check for repeated activities, or ensure that hotel stay durations meet minimum night requirements.

Table II below shows an example of some heuristic rules.

TABLE II
Commonsense constraints:
Example 1:
The first and last visiting city should be the same, if violated, then the feedback would be:

[symbol]

Example 2:
The entities such as cities, restaurants, attractions, accommodations visited, should be
exactly found in the reference box, otherwise the feedback would be (take restaurant
as example):

[symbol]

Example 3:
The entities of restaurants and attractions should not be repeated. If repetition is detected
in the plan, the feedback would be (take restaurant as example):

[symbol]

Example 4:
The accommodation choosed in the plan should meet the hotel's requirement, for example,
the overall number of stays should not be below the a specific number, otherwise, the
feedback would be:

[symbol]

Example 5:
The transportation information should be valid, for example, if the route takes invalid train
or flight from the reference box, then the feedback would be:

[symbol]

Hard constraints: Some requirements are explicitly written in the query, such as budget
limit, cuisine preference, or accommodation type. Here are some examples:
If the user wants a pet-friendly accommodation, then the hotel should be pet-friendly.
The overall of the cost in the plan should be under the budget limit in the query.
The restaurant chosen in the plan should meet the cuisine preference in the query. [symbol]
indicates data missing or illegible when filed

Also, the output of this stage can be a structured feedback signal. For instance, if the plan incorrectly ends in a different city, the feedback can be is_reasonalbe_visiting_city: fail, reason: The trip should be a closed circle.

Table III below shows an example of feedback generated by an LLM.

TABLE III

is_reasonalbe_visiting_city: fail, reason: The trip should
be a closed circle.
is_valid_restaurants: success
is_valid_attractions: success
is_valid_accommodation: fail, reason: The accommodation
Harlem cozy nights, Denver(Colorado) do not obey the
minimum nights rule.
is_valid_transportation: fail, reason: The transportation is
conflicting.
is_valid_information_in_current_city: success
is_valid_information_in_sandbox: fail, reason: The
accommodation in day 3 is invalid in the sandbox,
is_not_absent: success

In a subsequent data preparation stage, the inputs from the previous stages can be combined to form a training sample. For example, the query, the generated output itinerary, and the structured feedback signal can be assembled into a (query, output, feedback) triplet.

For example, the query about the San Francisco trip, the flawed itinerary generated by the model, and the corresponding multi-part feedback signal detailing the errors would form one such triplet. The entire dataset can then be reordered into a (Query, Feedback, Output) format to prepare it for the fine-tuning process.

Further in this example, in the fine-tuning stage, a target language model can be trained on the prepared dataset of travel planning examples. The input to this stage can be the entire dataset of (query, feedback, output) triplets. The model can be trained using supervised, auto-regressive fine-tuning. The output of this stage can be a fine-tuned model that has learned to generate a travel itinerary that is conditioned on both a user's query and a specific feedback signal.

In addition, in the inference phase, the fine-tuned model can be used to generate a new, high-quality travel plan. The input to the model can be a new user query along with a predetermined “success” feedback signal.

For example, regarding the travel planner, this success signal can be a structured input where all feedback criteria are explicitly set to “success,” for example: {is_reasonalbe_visiting_city: success, is_valid_restaurants: success, is_valid_accommodation: success, . . . }. By providing this success oriented feedback, the model can be guided to produce a final output that avoids the errors it was trained to recognize and avoid/correct (e.g., output a complete and correct travel itinerary).

Table IV below shows an example for part of an inference prompt.

TABLE IV

is_reasonalbe_visiting_city: success
is_valid_restaurants: success
is_valid_attractions: success
is_valid_accommodation: success
is_valid_transportation: success
is_valid_information_in_current_city: success
is_valid_information_in_sandbox: success
is_not_absent: success

Various experiments were carried out to evaluate the results of the feedback-aware fine-tuning method compared to a related example regarding supervised fine turning (SFT).

As shown in Table V below, the model according to embodiments outperforms other related-art methods.

TABLE V
Llama-3-8B as Planner

| | | Commonsense | | Hard Constraint | | Final |
|---|---|---|---|---|---|---|
| Planner | Delivery | Pass Rate | | Pass Rate | | Pass |
| (RQ4) | Rate | Micro | Macro | Micro | Macro | Rate |
| Vanilla | 94.4 | 49.5 | 1.1 | 7.9 | 0.0 | 0.0 |
| +SFT | 97.8 | 64.2 | 11.1 | 12.4 | 6.1 | 3.9 |
| +FAFT | 98.9 | 81.7 | 28.9 | 36.9 | 15.0 | 8.3 |

With reference to Table V above, a summary of example, non-limiting experimental results is shown, comparing the performance of the disclosed method according to embodiments against related art methods.

For example, according to an embodiment, advantages of the feedback-aware fine-tuning (FAFT) framework are demonstrated by the evaluation results presented in Table V. The results show a comparative performance analysis of a Llama-3-8B model configured as a planner under three conditions: a baseline “Vanilla” model (e.g., no subsequent fine tuning), a model enhanced with standard supervised fine-tuning (e.g., +SFT), and a model enhanced with the FAFT method (e.g., +FAFT) according to an embodiment of the present disclosure.

As shown above, the model fine-tuned with the FAFT method demonstrates superior performance across all measured criteria. Notably, the FAFT-enhanced model achieved a commonsense pass rate of 81.7% and a hard constraint pass rate of 36.9%, which are substantial improvements over the 64.2% and 12.4% achieved by the SFT model, respectively. This demonstrates that the FAFT method is significantly more effective at teaching the model to adhere to both implicit logical rules and explicit user-defined constraints.

Also, the FAFT model has a final pass rate of 8.3%, which is more than double the 3.9% rate of the standard SFT model and vastly superior to the 0.0% rate of the baseline model, which shows that the FAFT framework produces a more reliable and capable model for complex, instruction-driven tasks.

According to an embodiment, the AI device 100 can be configured to achieve improved fine-tuning of AI models. The AI device 100 can be used in various types of different situations.

According to one or more embodiments of the present disclosure, the AI device 100 can solve one or more technological problems in the existing technology, such as by implementing a feedback-aware fine-tuning framework that can directly teach a large language model (LLM) to adhere to complex constraints and quality criteria, thereby enhancing model reliability and alignment while avoiding the instability and high computational cost of reinforcement learning-based methods.

For example, embodiments of the present disclosure can address the deficiencies of the related art related art techniques, which suffer from an inability to teach complex reasoning using simple input-output pairs (SFT), or which rely on complex, unstable and resource-intensive training procedures (RLHF). Further, the disclosed method can overcome the limitations of self-refinement methods that are often inefficient and dependent on the capabilities of only the largest proprietary models, by providing a direct and stable supervised learning process that can enhance the instruction-following and reasoning capabilities of a wide range of language models.

Also, according to an embodiment, the AI device 100 configured with the pipeline method can be used in a mobile terminal, a smart TV, a home appliance, a robot, an infotainment system in a vehicle, etc.

For example, the disclosed FAFT framework can be applied in a wide range of interactive and automated applications, including sophisticated digital assistants, autonomous planning agents and advanced content creation tools. For example, according to an embodiment, an autonomous agent for task completion can be fine-tuned using the FAFT method to better understand a user's multi-step plan. Based on this improved understanding, the agent can perform a more relevant sequence of actions that more accurately addresses the user's complex needs, reducing errors and improving reliability.

For example, methods and systems disclosed herein have broad applicability across a wide range of industries and technical fields that utilize generative artificial intelligence. Language models fine-tuned with the disclosed FAFT framework can be well-suited for deployment in applications where the generation of accurate, reliable and constraint-adherent content is desired. This is particularly valuable in fields where errors or deviations from required formats can have significant consequences.

Non-limiting examples of such applications include the field of software development. The disclosed embodiments can be used to fine-tune code generation models to produce higher-quality software. For example, feedback signals could relate to adherence to a specific coding language's style guide, the avoidance of common security vulnerabilities and/or the optimization of code for performance. This allows for the creation of developer assistants that generate more reliable and secure code, reducing debugging time and improving overall software quality.

Further, the disclosed method can provide significant advantages for creative and professional writing industries. A model fine-tuned with FAFT can be integrated into word processors or content management systems to assist with drafting documents that must adhere to strict guidelines. For example, feedback can ensure that a generated contract or legal agreement includes all necessary clauses and uses correct legal terminology. In marketing, feedback can ensure that generated advertising copy maintains a specific brand voice and tone, resulting in more consistent and effective communication.

In an enterprise context, the method can be used to develop and train highly specialized assistants for various business functions. For example, a financial services firm can use FAFT to train a model that generates market analysis reports, with feedback ensuring that the reports are formatted correctly, include all required disclosures, and are based on validated data sources. This enables companies to build powerful, specialized AI tools that can reliably automate complex, knowledge-based work without the need to manually create massive datasets covering every possible rule and constraint.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, Python, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
generating, via a processor in the AI device, a plurality of training data instances based on:
providing a plurality of queries to a language model to generate a plurality of initial outputs, and
analyzing the plurality of initial outputs to generate plurality of feedback signals, each of the plurality of feedback signals including a natural language evaluation;
creating a structured training dataset by arranging the plurality of training data instances into a data structure including the plurality of queries, the plurality of initial outputs, and the plurality of feedback signals;
fine-tuning a target language model based on the structured training dataset to generate a fine-tuned target model; and
outputting the fine-tuned target model.

2. The method of claim 1, further comprising:
performing, by the fine-tuned target model, an inference task based on an input prompt including a new query and a predetermined feedback signal indicating a successful outcome, to generate a final output responsive to the new query.

3. The method of claim 2, wherein the predetermined feedback signal indicating a successful outcome includes a plurality of feedback fields, and
wherein each of the plurality of feedback fields is set to a value representing success.

4. The method of claim 1, wherein the analyzing the plurality of initial outputs is performed by a feedback generator based on a set of predefined heuristic rules.

5. The method of claim 4, wherein the set of predefined heuristic rules includes at least one of a commonsense constraint for checking logical consistency within a corresponding initial output or a hard constraint for verifying adherence to a requirement specified in a corresponding query.

6. The method of claim 1, wherein the creating the structured training dataset includes:
arranging each of the plurality of training data instances in an order that includes a corresponding query and a corresponding feedback signal preceding a corresponding initial output to condition the target language model during the fine-tuning.

7. The method of claim 1, wherein the fine-tuning is supervised fine-tuning performed in an auto-regressive manner.

8. The method of claim 1, wherein the creating the structured training dataset further includes:
combining the plurality of training data instances with a plurality of ground truth data instances to create an augmented training dataset,
wherein each of the plurality of ground truth data instances includes a ground truth output and a corresponding ground truth feedback signal.

9. The method of claim 1, wherein the generating the plurality of training data instances includes setting a temperature hyper-parameter of the language model to a value greater than zero.

10. The method of claim 1, wherein the plurality of queries are based on a task selected from a group including one or more of travel planning, code generation, creative writing, legal document drafting, and customer service response generation.

11. An artificial intelligence (AI) device, comprising:
a memory configured to store information for a language model; and
a controller configured to:
generate, via a processor in the AI device, a plurality of training data instances based on providing a plurality of queries to a language model to generate a plurality of initial outputs, and analyzing the plurality of initial outputs to generate plurality of feedback signals, each of the plurality of feedback signals including a natural language evaluation,
create a structured training dataset by arranging the plurality of training data instances into a data structure including the plurality of queries, the plurality of initial outputs, and the plurality of feedback signals,
fine-tune a target language model based on the structured training dataset to generate a fine-tuned target model, and
output the fine-tuned target model.

12. The AI device of claim 11, wherein the controller is further configured to:
perform, by the fine-tuned target model, an inference task based on an input prompt including a new query and a predetermined feedback signal indicating a successful outcome, to generate a final output responsive to the new query.

13. The AI device of claim 12, wherein the predetermined feedback signal indicating a successful outcome includes a plurality of feedback fields, and
wherein each of the plurality of feedback fields is set to a value representing success.

14. The AI device of claim 11, wherein the analyzing the plurality of initial outputs is performed by a feedback generator based on a set of predefined heuristic rules.

15. The AI device of claim 14, wherein the set of predefined heuristic rules includes at least one of a commonsense constraint for checking logical consistency within a corresponding initial output or a hard constraint for verifying adherence to a requirement specified in a corresponding query.

16. The AI device of claim 11, wherein the controller is further configured to:
create the structured training dataset by arranging each of the plurality of training data instances in an order that includes a corresponding query and a corresponding feedback signal preceding a corresponding initial output to condition the target language model during the fine-tuning.

17. The AI device of claim 11, wherein the controller is further configured to:
fine-tune the target language model based on supervised fine-tuning performed in an auto-regressive manner.

18. The AI device of claim 11, wherein the controller is further configured to:
combine the plurality of training data instances with a plurality of ground truth data instances to create an augmented training dataset,
wherein each of the plurality of ground truth data instances includes a ground truth output and a corresponding ground truth feedback signal.

19. The AI device of claim 11, wherein the controller is further configured to:
set a temperature hyper-parameter of the language model to a value greater than zero for generating the plurality of training data instances.

20. A non-transitory computer readable medium storing computer-executable instructions that when executed by a processor, cause the processor to perform the operations of:
generating a plurality of training data instances based on:
providing a plurality of queries to a language model to generate a plurality of initial outputs, and
analyzing the plurality of initial outputs to generate plurality of feedback signals, each of the plurality of feedback signals including a natural language evaluation;
creating a structured training dataset by arranging the plurality of training data instances into a data structure including the plurality of queries, the plurality of initial outputs, and the plurality of feedback signals;
fine-tuning a target language model based on the structured training dataset to generate a fine-tuned target model; and
outputting the fine-tuned target model.
